(19) United States
(12) Patent Application Publication
(10) Pub. No.: US 2007/0172415 A1
(43) Pub. Date: Jul. 26, 2007

(54) PROCESS FOR THE PRODUCTION OF ZINC OXIDE POWDER

(75) Inventors: Guido ZIMMERMANN, Rodenbach (DE); Stipan Katusic, Kelkheim (DE); Michael Kraemer, Schoeneck (DE); Horst Miess, Kahl (DE); Nuh Yilmaz, Hanau (DE); Guenther Michael, Karlstein (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSA AG, Duesseldorf (DE)

(21) Appl. No.: 11/612,112

(22) Filed: Dec. 18, 2006

(30) Foreign Application Priority Data
Dec. 16, 2005 (DE) 10 2005 060 121.9

(51) Int. Cl. C01G 9/02

(52) U.S. Cl. 423/622

(57) ABSTRACT

Zinc oxide powder is prepared by a process having the following steps a) generating of a zinc vapor-containing stream in a vaporization zone; b) oxidizing the zinc vapor by reaction with an oxygen-containing gas thereby forming zinc oxide powder in an oxidation zone; and c) cooling of the reaction mixture with water or an inert gas, and separation of the zinc oxide powder in a cooling/isolation zone, wherein aa) in the vaporization zone, a gas stream of an inert gas and a fuel gas is passed through a zinc melt which has a temperature of 450 to <900° C., thereby forming zinc vapor, the content of fuel gas being 1 to 50 vol. %, based on the sum of inert gas and fuel gas, and the molar quotient of zinc vapor to fuel gas being 0.01 to 50, and bb) in the oxidation zone, a second gas stream, which contains an oxygen-containing gas and steam, is added to the gas stream of zinc vapor, fuel gas and inert gas in an amount such that the temperature in the oxidation zone is from 500 to 1100° C., wherein the content of oxygen at least suffices to convert all fuel gas from the vaporization zone and the zinc vapor, and the steam is created by the reaction of a fuel gas with the oxygen-containing gas which is introduced into the oxidation zone

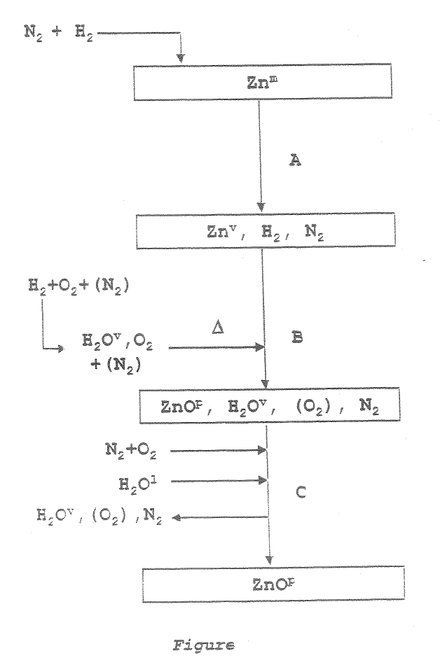

### BACKGROUND OF THE INVENTION

1. Field of the Invention

The application concerns a process for the production of zinc oxide powder.

2. Description of the Invention

Zinc oxide powders are used in colorants, paints, in resins and fibers. An important sector is represented by the use of zinc oxide powders in the cosmetics field, in particular as a component of sunscreen formulations.

In principle, two options are available for the synthesis of zinc oxide powders, wet chemical processes and gas phase processes. As a rule, in the wet chemical processes, zinc compounds which can be thermally converted into zinc oxide, such as for example zinc hydroxide, zinc oxalate or zinc carbonate are used as the starting material. It is usually a disadvantage in wet chemical methods that the zinc oxide particles produced agglomerate into larger units, which are particularly undesirable in cosmetics applications. Further, impurities due to process materials and starting materials can only be removed from the finished product with great difficulty, or not at all.

The process, usually performed as a batch process, comprises filtration, drying and if necessary milling of the particles and is relatively cost-intensive,

Gas phase processes or pyrogenic processes make lower-cost production possible, These include for example the French process, by means of which zinc oxide can be produced on an industrial scale,

In these processes, oxidation of zinc vapor takes place, Disadvantages in this are the formation of large aggregates from primary particles and a low BET surface area.

An improved product and improved processes compared to the known art are for example described in U.S. Pat. No. 6,335,002, DE-A-10212680, WO 2005/028565 and JP63 147823.

From U.S. Pat. No. 6,335,002, a process is known for the production of zinc oxide powder, wherein zinc vapor is transferred by means of an inert gas into an oxidation zone, where it is oxidized in an atmosphere of an oxidizing gas which contains oxygen and steam. Such an atmosphere can also be created by combustion of an oxygen-containing gas with hydrogen or propane, wherein an excess of oxygen is used. Zinc vapor and the oxygen/steam mixture are separately injected by means of nozzles into a reactor, in which the oxidation takes place. A disadvantage in this process is that during the generation and introduction of the zinc vapor into the oxidation zone, the zinc vapor can already react with traces of oxygen present and form zinc oxide nuclei which can make the subsequent product inhomogeneous. Further, the temperatures mentioned as preferred in the stated process are relatively high. If it is desired to avoid losses in BET surface area due to sintering of the primary particles, the zinc concentration in the reaction zone must be kept relatively low, which is not desirable from the economic point of view

From DE-A-10212680, a process is known for the production of zinc oxide powder, wherein zinc powder is converted into zinc oxide powder in four consecutive reaction zones. These four zones are: a vaporization zone, nucleation zone, oxidation zone and quenching zone. In the vaporization zone, the zinc powder is vaporized in a flame of air and/or oxygen and a fuel gas, preferably hydrogen, during which no oxidation of the zinc powder takes place. In the nucleation zone, the hot reaction mixture from the vaporization zone is cooled to temperatures below the boiling point of zinc In the oxidation zone, the mixture from the nucleation zone is oxidized with air and or oxygen h the quenching zone, the oxidation mixture is cooled by addition of cooling gas. A disadvantage in this process is the cooling of the zinc vapor, which can only be controlled at considerable expense and does not make economic sense.

From WO 2005/028565, a process is known for the production of zinc oxide powder. wherein a mixture which contains zinc vapor, a fuel gas and the reaction products from the oxidation of the fuel gas with an oxygen-containing gas is reacted in a flame with a stoichiometric excess of an oxygen-containing gas. With the use of hydrogen as the fuel gas, water is formed as a reaction product. The hot reaction mixture is next cooled in a quench zone and the zinc oxide powder separated from the gas stream.

From JP 63 147823, a process is known wherein a mixture of inert gas and fuel gas, which transfers zinc vapor into an oxidation zone, is passed over the surface of the zinc melt. A disadvantage in this process is that in the mode disclosed a regulated, defined zinc vapor input is not possible. The exchange interface between inert gas/fuel gas and the zinc vapor is small and as a result the flow passed into the oxidation zone is not laden with a constant amount of zinc vapor, This can lead to a reduction in the yield and to a decrease in the product quality

The known art describes various options for the gas phase synthesis, with the aim of attaining a higher BET surface area, improved transparency and higher UV protection. In the final analysis, a common feature of all these attempts is the oxidation of zinc vapor. The cited art shows that with otherwise identical starting substances, even small changes in the process can result in differing zinc oxide powders. The increasing requirements as regards the uniformity and fine particle size of the zinc oxide powder render continual improvement of the processes necessary. In particular, the known processes result in caked materials in the vaporization zone and oxidation zone, which must subsequently be laboriously removed.

### SUMMARY OF THE INVENTION

It is an object of the present to provide an improved process for the production of zinc oxide powder, which avoids the disadvantages of the art.

This and other objects have been achieved by the present invention the first embodiment of which includes a process for the production of zinc oxide powder, comprising:

a) generating of a zinc vapor-containing stream in a vaporization zone;

b) oxidizing the zinc vapor by reaction with an oxygen-containing gas thereby forming zinc oxide powder in an oxidation zone; and

c) cooling of the reaction mixture with water or an inert gas, and separation of the zinc oxide powder in a cooling/isolation zone,

wherein

aa) in the vaporization zone, a gas stream of an inert gas and a fuel gas is passed through a zinc melt which has a temperature of 450 to <900° C., thereby forming zinc vapor, the content of fuel gas being 1 to 50 vol. %, based on the sum of inert gas and fuel gas, and the molar quotient of zinc vapor to fuel gas being 0.01 to 50, and

bb) in the oxidation zone, a second gas stream, which contains an oxygen-containing gas and steam, is added to the gas stream of zinc vapor, fuel gas and inert gas in an amount such that the temperature in the oxidation zone is from 500 to 1100° C.,
wherein
the content of oxygen at least suffices to convert all fuel gas from the vaporization zone and the zinc vapor, and
the steam is created by the reaction of a fuel gas with the oxygen-containing gas which is introduced into the oxidation zone,

### BRIEF DESCRIPTION OF DRAWING

The FIGURE is a diagrammatic representation of the process according to the invention.

### DETAILED DESCRIPTION OF THE INVENTION

The present invention is a process for the production of zinc oxide powder, comprising

a) generation of a zinc vapor-containing stream in a vaporization zone

b) oxidation of the zinc vapor by reaction with an oxygen-containing gas with the formation of zinc oxide powder in an oxidation zone, and

c) cooling of the reaction mixture with water or an inert gas and separation of the zinc oxide powder in a cooling/isolation zone,

wherein

aa) in the vaporization zone, a gas stream of an inert gas and a fuel gas is passed through a zinc melt which has a temperature of 450 to <900° C., preferably 750 to 850° C., with the formation of zinc vapor, the content of fuel gas being 1 to 50 vol. %, preferably 3 to 30 vol %, based on the sum of inert gas and fuel gas, and the molar quotient of zinc vapor to fuel gas being 0.01 to 50, preferably 10 to 30 and

bb) in the oxidation zone, a second gas stream, which contains an oxygen-containing gas and steam is added to the gas stream of zinc vapor, fuel gas and inert gas in an amount such that the temperature in the oxidation zone is from 500 to 1100° C., preferably 750 to 1000° C. and especially preferably 800 to 900° C., wherein
the content of oxygen at least suffices to convert all fuel gas from the vaporization zone and the zinc vapor, and
the steam is created by the reaction of a fuel gas with the oxygen-containing gas which is introduced into the oxidation zone.

The temperature in aa) includes all values and subvalues therebetween, especially including 500 550, 600, 650 700 750, 800 and 850° C. The content of fuel in aa) includes all values and subvalues therebetween, especially including 5, 10, 15, 20, 25, 30, 35, 40 and 45 vol. % The molar quotient of zinc vapor to fuel gas in aa) includes all values and subvalues therebetween especially including 0.05, 0.1, 0.5, 1, 5, 10, 15, 20, 25, 30, 35, 40 and 45 The temperature in bb) includes all values and subvalues therebetween, especially including 500, 550, 600 650, 700, 750, 800, 850, 900, 950, 100 and 1050° C.

As the fuel gas, hydrogen, methane, ethane, propane, butane and/or natural gas can preferably be used, hydrogen being particularly preferable

The zinc which is used for the generation of the zinc vapor preferably has a purity of at least 99.5 wt. %. The purity includes all values and subvalues therebetween, especially including 99.6, 99.7, 99.8, 99.9 and 100 wt. %. Here, more advantageously, the content of lead is at most 100 ppm, of arsenic 15 ppm, of cadmium 75 ppm, of iron 1000 ppm, of antimony 5 ppm and of mercury 5 ppm. Corresponding values apply for the zinc oxide produced by the process according to the invention.

The oxygen-containing gas introduced into the oxidation zone preferably contains an excess of oxygen, based on the quantity of zinc vapor and fuel gas to be oxidized. The lambda value, which is defined as the quotient of the oxygen content of the oxygen-containing gas, divided by the sum of zinc vapor and fuel gas, each in mol/hr, is preferably 1 to 20 and especially preferably 3 to 10. The lambda value includes all values and subvalues therebetween, especially including 2, 4, 6, 8, 10, 12, 14, 16 and 18.

The average residence time in the oxidation zone is preferably 5 to 1000 milliseconds. The average residence time includes all values and subvalues therebetween, especially including 10, 20, 30, 40, 50, 60, 70, 80, 90, 100, 150, 200, 250, 300, 350, 400, 450, 500, 550, 600, 650, 700, 750, 800, 850, 900 and 950 msecs The cooling of the reaction mixture is preferably effected with a mixture of air and water, the mixture preferably having a composition of 2-100 m³ air/kg water. The composition includes all values and subvalues therebetween, especially including 5, 10, 15, 20, 25, 30, 35, 40, 45, 50, 55, 60, 65, 70, 75, 80, 85, 90 and 95 m³ air/kg water. The air/water mixture is ideally suited for the rapid cooling of the reaction stream.

The Figure is a diagrammatic representation of the process according to the invention. In this figure, p=powder, m=melt, v=vapor, 1=liquid, Δ=energy input, A=vaporization zone, B=oxidation zone and C=cooling/isolation zone.

Having generally described this invention, a further understanding can be obtained by reference to certain specific examples which are provided herein for purposes of illustration only, and are not intended to be limiting unless otherwise specified

### EXAMPLES

Examples

The BET surface area was determined as per DIN 66131.

Determination of the grit content: ca. 5 g of powder were made up to ca. 100 g with deionized water. The sample was predispersed for five minutes at 2000 rpm with a laboratory dissolver. It was then dispersed for five minutes at 10000 rpm with the Ultra Turrax, After completion of the dispersion operation, the dispersion was fed onto a 45 μm sieve. The sieve was then placed in a forced air drying cabinet (T=100-120° C.) for drying. After ca. 15 minutes, the sieve residue was dry and could be weighed.

% Grit>45 μm=[weight of particles>45 μm (g)/weight of powder taken (g)]* 100

Example 1 according to invention: A mixture of 32 mol/hr nitrogen and 1.7 mol/hr hydrogen was passed through a zinc melt heated to 850° C., as a result of which 39 mol/hr of zinc were vaporized. The mixture of zinc vapor, nitrogen and hydrogen was passed into an oxidation zone. Further, the reaction products from the reaction of 1563 mol/hr air and 357 mol/hr of hydrogen were passed into the oxidation zone. The reaction products consist of 1305 mol/hr nitrogen, 357 mol/hr steam and 168 mol/hr oxygen. The heat generated by the reaction and the heat generated by the oxidation of zinc vapor with oxygen results in a temperature of 880° C. in the oxidation zone. The average residence time in the oxidation zone was 51 msecs. In a subsequent cooling step, the reaction mixture was cooled to a temperature of 300° C. with 167 mol/hr of water and 2232 mol/hr air and the zinc oxide powder for ed was separated on filters.

The powder produced by the process according to the present invention had a BET surface area of 30 m²/g and no grit content,

Example 2 (Comparison Example) was performed analogously to Example 1, however the gas mixture passed through the zinc melt contained no hydrogen.

Example 3 (Comparison Example) was performed analogously to Example 2, however the oxidation zone contained no steam

Example 4 Comparison Example was performed analogously to Example 1, however air and hydrogen were selected in quantities such that a temperature of 1242° C. results in the oxidation zone as opposed to 850° C. in Example 1.

All starting materials and quantities used and analytical data for the zinc oxide powders are shown in Table 1.

The process according to the present invention enables the production of high surface area zinc oxide powder, which has only a low grit content, or none.

TABLE 1
Starting materials and quantities used; analytical
data for the zinc oxide powders

| | | Example | | | |
|---|---|---|---|---|---|
| | | 1 | 2 | 3 | 4 |
| Vaporizer | | | | | |
| Nitrogen | Mol/hr | 32 | 36 | 40 | 30 |
| Hydrogen | Mol/hr | 1.7 | 0.0 | 0.0 | 1.6 |
| Zinc | Mol/hr | 39 | 26 | 29 | 29 |
| Temperature | ° C. | 850 | 830 | 830 | 840 |
| zinc/fuel gas | mol/mol | 23.6 | — | — | 18.3 |
| nitrogen/fuel gas | mol/mol | 19.0 | — | — | 19.0 |
| Flame | | | | | |
| Air | Mol/hr | 1563 | 1518 | 446 | 1339 |
| Hydrogen | Mol/hr | 357 | 170 | 0 | 268 |
| Oxidation | | | | | |
| Nitrogen | Mol/hr | 1305 | 1199 | 353 | 1058 |
| Steam | Mol/hr | 357 | 170 | 0 | 268 |
| Oxygen | Mol/hr | 168 | 234 | 94 | 147 |
| Temperature | ° C. | 880 | 722 | 952 | 1242 |
| oxygen/(zinc + fuel gas) | mol/mol | 4.1 | 9.0 | 3.2 | 4.8 |
| residence time | msecs | 51 | 129 | 362 | 93 |
| Quench | | | | | |
| Water | Mol/hr | 167 | 133 | 56 | 444 |
| Air | mol/hr | 2232 | 1339 | 446 | 1786 |
| air/water | m³/g | 17 | 13 | 10 | 5 |
| Temperature | ° C. | 300 | 270 | 204 | 318 |
| Analysis | | | | | |
| BET | m²/g | 30.0 | 21.0 | 17 | 12 |
| Grit | wt. % | 0.0 | 0.2 | 0.25 | 0.68 |

German patent application 10 2005 060 121.9 filed Dec. 16, 2005, is incorporated herein by reference.

Numerous modifications and variations on the present invention are possible in light of the above teachings. It is therefore to be understood that within the scope of the appended claims, the invention may be practiced otherwise than as specifically described herein.

1. A process for the production of zinc oxide powder, comprising:
a) generating of a zinc vapor-containing stream in a vaporization zone;
b) oxidizing the zinc vapor by reaction with an oxygen-containing gas thereby forming zinc oxide powder in an oxidation zone; and
c) cooling of the reaction mixture with water or an inert gas, and separation of the zinc oxide powder in a cooling/isolation zone,
wherein
aa) in the vaporization zone, a gas stream of an inert gas and a fuel gas is passed through a zinc melt which has a temperature of 450 to <900° C., thereby forming zinc vapor, the content of fuel gas being 1 to 50 vol. %, based on the sum of inert gas and fuel gas, and the molar quotient of zinc vapor to fuel gas being 0.01 to 50, and
bb) in the oxidation zone, a second gas stream, which contains an oxygen-containing gas and steam, is added to the gas stream of zinc vapor, fuel gas and inert gas in an amount such that the temperature in the oxidation zone is from 500 to 1100C.,
wherein
the content of oxygen at least suffices to convert all fuel gas from the vaporization zone and the zinc vapor, and
the steam is created by the reaction of a fuel gas with the oxygen-containing gas which is introduced into the oxidation zone.

2. The process according to claim 1, wherein an excess of the oxygen-containing gas is passed into the oxidation zone.

3. The process according to claim 1, wherein the average residence time in the oxidation zone is 5 to 1000 milliseconds.

4. The process according to claim 1, wherein the cooling is effected with a mixture of air and water.

5. The process according to claim 1, wherein said zinc melt has a temperature of 750 to 850° C.

6. The process according to claim 1, wherein said content of fuel gas is 3 to 30 vol. %, based on the sum of inert gas and fuel gas.

7. The process according to claim 1, wherein said molar quotient of zinc vapor to fuel gas is 10 to 30.

8. The process according to claim 1, wherein the temperature in the oxidation zone is from 750 to 1000° C.

9. The process according to claim 1, wherein said fuel gas is hydrogen, methane, ethane, propane, butane, natural gas or mixtures thereof.

10. The process according to claim 1, wherein the zinc which is used for the generation of the zinc vapor has a purity of at least 99.5 wt. %.

11. The process according to claim 10, wherein said zinc has content of lead of at most 100 ppm of arsenic of at most 15 ppm of cadmium of at most 75 ppm, of iron of at most 1000 ppm, of antimony of at most 5 ppm and of mercury of at most 5 ppm.

12. The process according to claim 1, wherein a quotient of the oxygen content of the oxygen-containing gas, divided by the sum of zinc vapor and fuel gas, each in mol/hr is 1 to 20.

13. The process according to claim 1, wherein said cooling of the reaction mixture is effected with a mixture of air and water, the mixture having a composition of 2-100 m³ air/kg water.
